(19) United States
(12) Patent Application Publication
(10) Pub. No.: US 2024/0343876 A1
(43) Pub. Date: Oct. 17, 2024

(54) HEAT-EXPANDABLE MICROSPHERES, COMPOSITION, AND FORMED PRODUCT

(71) Applicant: MATSUMOTO YUSHI-SEIYAKU CO., LTD., Yao-shi, Osaka (JP)

(72) Inventors: Tomohiro YAMAUCHI, Yao-shi, Osaka (JP); Takayuki AOKI, Yao-shi, Osaka (JP)

(73) Assignee: MATSUMOTO YUSHI-SEIYAKU CO., LTD., Yao-shi, Osaka (JP)

(21) Appl. No.: 18/580,044

(22) PCT Filed: Mar. 28, 2022
(86) PCT No.: PCT/JP2022/014864

§ 371 Date: Jan. 17, 2024

(30) Foreign Application Priority Data
Jul. 29, 2021 (JP) 2021-124372

(51) Int. Cl. C08J 9/224; C08J 9/14; C08J 9/18; C08J 9/32

(52) U.S. Cl. CPC C08J 9/224; C08J 9/146; C08J 9/18; C08J 9/32; C08J 2201/032; C08J 2203/146; C08J 2203/22; C08J 2333/20

(57) ABSTRACT

Provided are heat-expandable microspheres which have high expansion performance to exhibit highly thermoresponsive expansion behavior in short heating time and the application thereof. The heat-expandable microspheres are composed of a thermoplastic resin shell and a blowing agent encapsulated therein and vaporizable by heating. The thermoplastic resin is a polymer of a polymerizable component containing a nitrile monomer, and the nitrile monomer contains acrylonitrile and methacrylonitrile in a ratio of 100 parts by weight/40 parts by weight to 80 parts by weight. The blowing agent contains a blowing agent (a) having a specific heat in the range from 0.8 J/g·K to 2.0 J/g·K. Also disclosed is a composition containing the heat-expandable microspheres and a formed product manufactured by forming the composition.

### CROSS-REFERENCE TO RELATED APPLICATIONS

This application is a National Stage of International Application No. PCT/JP2022/014864 filed Mar. 28, 2022, claiming priority from Japanese Patent Application No. 2021-124372 filed Jul. 29, 2021.

### BACKGROUND OF THE INVENTION

### Field of the Invention

The present invention relates to heat-expandable microspheres, composition, and formed product.

### Description of the Related Art

Heat-expandable microspheres, which are composed of a thermoplastic resin shell and a blowing agent encapsulated therein, are used in various fields of application including making resins and paints lighter, patterning wall paper and manufacturing inks for tridimensional design.

For example, PTL 1 discloses heat-expandable microspheres having high expansion performance which are composed of thermoplastic resin polymerized from a polymerizable component containing 20 wt % to 80 wt % of acrylonitrile, 20 wt % to 80 wt % of a monomer selected from acrylate esters, 0 wt % to 10 wt % of methacrylonitrile, and 0 wt % to 40 wt % of a monomer selected from methacrylate esters as ethylenically unsaturated monomers wherein the total amount of the acrylonitrile and the acrylate ester ranges from 50 wt % to 100 wt % of the ethylenically unsaturated monomers; and are also composed of a blowing agent containing at least one of methane, ethane, propane, isobutane, n-butane and isopentane. The heat-expandable microspheres enable lightweight resins and paints.

### Problems to be Solved by the Invention

The heat-expandable microspheres in PTL 1, however, requires long time to thermally expand to their intended expansion ratio and thus lengthen the duration of expansion process and decrease production efficiency. On the other hand, increasing the heating temperature for shortening the thermal expansion process causes shrinkage or so-called collapse of expanded microspheres due to excessive heating, and fails to manufacture microspheres expanded to a target expansion ratio.
PTL 1: WO2007/091961

### SUMMARY OF THE INVENTION

It is therefore an object of the present invention to provide heat-expandable microspheres which have high expansion performance to exhibit highly thermoresponsive expansion behavior in short heating time and are resistant to collapse after expansion; and application thereof.

Following diligent study the present inventors have discovered that heat-expandable microspheres composed of a specific thermoplastic resin shell and a specific blowing agent encapsulated therein solve the above-mentioned problems and have achieved the present invention.

The heat-expandable microspheres of the present invention are composed of a thermoplastic resin shell and a blowing agent encapsulated therein and vaporizable by heating. The thermoplastic resin is a polymer of a polymerizable component containing a nitrile monomer. The nitrile monomer contains acrylonitrile and methacrylonitrile and the amount of the methacrylonitrile ranges from 40 parts by weight to 80 parts by weight to 100 parts by weight of the acrylonitrile. The blowing agent contains a blowing agent (a) having a specific heat ranging from 0.8 J/g·K to 2.0 J/g·K.

The heat-expandable microspheres of the present invention preferably have a specific heat ranging from 1.05 J/g·K to 1.5 J/g·K.

The blowing agent (a) of the heat-expandable microspheres of the present invention preferably contains at least one substance selected from fluoroketone and hydrofluoroether.

The polymerizable component constituting the heat-expandable microspheres of the present invention preferably contains at least 25 wt % of the nitrile monomer.

The heat-expandable microspheres of the present invention preferably have a particle size distribution in which the ratio of the 50-% cumulative volume particle size (A50) to the 10-% cumulative volume particle size (A10), A50/A10, is at least 1.1.

The heat-expandable microspheres of the present invention preferably have a particle size distribution in which the ratio of the 90-% cumulative volume particle size (A90) to the 50-% cumulative volume particle size (A50), A90/A50, ranges from 1.1 to 5.5.

The hollow particles of the present invention are the product manufactured by expanding the heat-expandable microspheres mentioned above.

The fine-particle-coated hollow particles of the present invention are composed of the hollow particles mentioned above and a particulate material coating the outer surface of the shell of the hollow particles.

The composition of the present invention is composed of a base component and at least one selected from the heat-expandable microspheres, hollow particles and fine-particle-coated hollow particles.

The composition of the present invention preferably is liquid or paste.

The formed product of the present invention is manufactured by forming the composition.

### Advantageous Effects of the Invention

The heat-expandable microspheres of the present invention have high expansion performance to exhibit highly thermoresponsive expansion behavior in short heating time and prevent their collapse after expansion.

The hollow particles of the present invention are manufactured by expanding the heat-expandable microspheres, and are lightweight and resistant to collapse.

The fine-particle-coated microspheres of the present invention are manufactured by coating the outer surface of the shell of the hollow particles with a particulate material and are lightweight and resistant to collapse.

The composition of the present invention contains at least one selected from the heat-expandable microspheres, hollow particles and fine-particle-coated microspheres and is manufactured into a formed product which is lightweight and resistant to collapse.

The formed product of the present invention is manufactured by forming the composition and is lightweight and resistant to collapse.

### BRIEF DESCRIPTION OF THE DRAWINGS

FIG. 1: A schematic diagram of an example of the heat-expandable microspheres of the present invention

FIG. 2: A schematic diagram of an example of the fine-particle coated hollow resin microspheres of the present invention

### REFERENCE NUMBERS LIST

Reference numbers used to identify various features in the drawings include the following:
1 Fine-particle-coated hollow particles
2 Shell
3 Hollow core
4 Fine-particle material (in a state of adhesion)
5 Fine-particle material (in a state of fixation in a dent)
6 Shell of thermoplastic resin
7 Blowing agent

### DETAILED DESCRIPTION OF PREFERRED EMBODIMENTS

The heat-expandable microspheres of the present invention are specifically described as follows and in reference to the drawings. However, the present invention should not be construed as being limited thereto.

### Heat-Expandable Microspheres

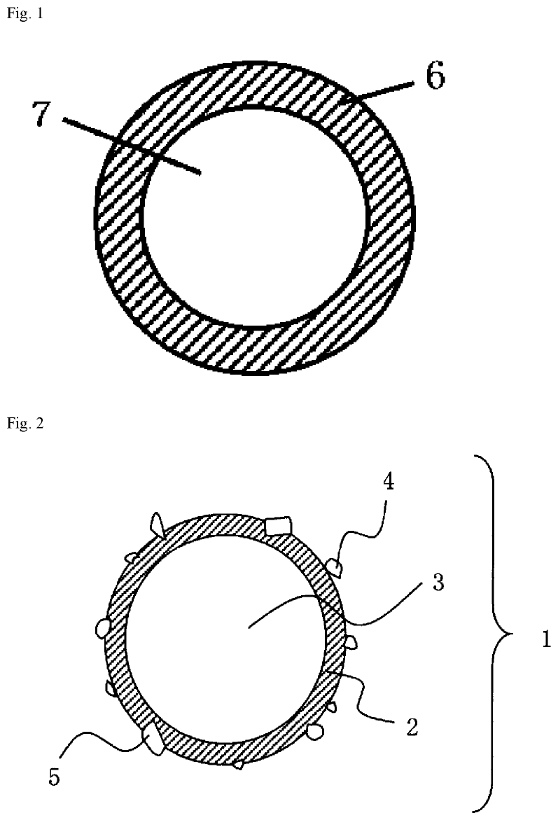

As shown in FIG. 1, the heat-expandable microspheres of the present invention are composed of a shell 6 of a thermoplastic resin and a blowing agent (core) 7 encapsulated therein and vaporizable by heating. The heat-expandable microspheres have a core-shell structure and the whole of a microsphere is thermally expandable (a microsphere wholly expandable by heating). The thermoplastic resin is a polymer of the polymerizable component.

The polymerizable component is polymerized into a thermoplastic resin which constitutes the shell of the heat-expandable microspheres. The polymerizable component essentially contains a monomer having one radically reactive carbon-to-carbon double bond per molecule (hereinafter sometimes referred to as a monomer component) and optionally contains a crosslinking agent having at least two radically reactive carbon-to-carbon double bonds per molecule (hereinafter sometimes referred to as a crosslinking agent). The monomer component and the crosslinking agent are both reactive in addition reaction and the crosslinking agent introduces a crosslinking structure in the thermoplastic resin.

The polymerizable component contains a nitrile monomer as a monomer component. The nitrile monomer contains acrylonitrile and methacrylonitrile and the amount of the methacrylonitrile ranges from 40 parts by weight to 80 parts by weight to 100 parts by weight of the acrylonitrile.

The acrylonitrile and methacrylonitrile are essentially contained in the nitrile monomer and the amount of the methacrylonitrile ranges from 40 parts by weight to 80 parts by weight to 100 parts by weight of the acrylonitrile. The amount of the methacrylonitrile lower than 40 parts by weight results in excessively rigid shell of the heat-expandable microspheres because of increased block polymerization of the acrylonitrile and such heat-expandable microspheres require longer heating time to expand to their maximum expansion ratio. On the other hand, the amount of the methacrylonitrile higher than 80 parts by weight results in insufficient heat resistance and gas-barrier effect of the heat-expandable microspheres because of increased block polymerization of the methacrylonitrile and such heat-expandable microspheres fail to prevent their collapse after thermal expansion. The amount of the methacrylonitrile within the range of 40 parts by weight to 80 parts by weight is considered to enable proper random polymerization of the acrylonitrile and methacrylonitrile to attain the compromise between good thermoresponsiveness of the heat-expandable microspheres and prevention of their collapse after thermal expansion. The upper limit of the amount of the methacrylonitrile preferably is 78 parts by weight, more preferably 76 parts by weight, further more preferably 74 parts by weight, and yet further more preferably 70 parts by weight. On the other hand, the lower limit of the amount preferably is 42 parts by weight, more preferably 44 parts by weight, further more preferably 46 parts by weight, yet further more preferably 50 parts by weight, and most preferably 53 parts by weight.

The nitrile monomer contained in the polymerizable component as a monomer component can include fumaronitrile and maleonitrile other than acrylonitrile and methacrylonitrile.

The amount of the nitrile monomer contained in the polymerizable component is not specifically restricted and preferably is at least 25 wt %. At least 25 wt % of the nitrile monomer improves the gas-barrier effect of the shell of the resultant microspheres and the stretchability of the softened shell, and thus the resultant microspheres exhibit good expansion performance at low temperature. The upper limit of the amount of the nitrile monomer preferably is 99.7 wt %, more preferably 99.5 wt %, further more preferably 99 wt %, and most preferably 98.5 wt %. On the other hand, the lower limit of the amount preferably is 30 wt %, more preferably 35 wt %, further more preferably 40 wt %, and most preferably 50 wt %.

The polymerizable component can contain a monomer other than the nitrile monomer (hereinafter sometimes referred to as other monomers) as the monomer component.

Other monomers include, for example, vinyl halide monomers, such as vinyl chloride; vinylidene halide monomers, such as vinylidene chloride; vinyl ester monomers, such as vinyl acetate, vinyl propionate and vinyl butyrate; carboxy-containing monomers, such as unsaturated monocarboxylic acids including acrylic acid, methacrylic acid, ethacrylic acid, crotonic acid and cinnamic acid, unsaturated dicarboxylic acids including maleic acid, itaconic acid, fumaric acid, citraconic acid and chloromaleic acid, anhydrides of unsaturated dicarboxylic acids, and monoesters of unsaturated dicarboxylic acids including monomethyl maleate, monoethyl maleate, monobutyl maleate, monomethyl fumarate, monoethyl fumarate, monomethyl itaconate, monoethyl itaconate and monobutyl itaconate; (meth)acrylate monomers, such as methyl (meth)acrylate, ethyl (meth)acrylate, n-butyl (meth)acrylate, t-butyl (meth)acrylate, 2-ethylhexyl (meth)acrylate, stearyl (meth)acrylate, phenyl (meth)acrylate, isobornyl (meth)acrylate, cyclohexyl (meth)acrylate, benzyl (meth)acrylate and 2-hydroxyethyl (meth)acrylate; (meth)acrylamide monomers, such as acrylamide, substituted acrylamide, methacrylamide and substituted methacrylamide; maleimide monomers, such as N-phenyl maleimide and N-cyclohexyl maleimide; styrene monomers, such as styrene and α-methyl styrene; ethylenically unsaturated monoolefin monomers, such as ethylene, propylene and isobutylene; vinyl ether monomers, such as vinyl methyl ether, vinyl ethyl ether and vinyl isobutyl ether; vinyl ketone monomers, such as vinyl methyl ketone; N-vinyl monomers, such as N-vinyl carbazole and N-vinyl pyrolidone; and vinyl naphthalene salts. Apart of or the whole of the carboxyl groups of the carboxy-containing monomers can be neutralized during or after the polymerization. In the present invention, the word, (meth)acrylate, means acrylate or methacrylate, and the word, (meth)acryl, means acryl or methacryl. One of or a combination of at least two of the other monomers can be used.

The polymerizable component preferably contains a carboxy-containing monomer to control the expansion-initiation temperature of the resultant microspheres.

The amount of the carboxy-containing monomer in the polymerizable component is not specifically restricted, and preferably ranges from 5 wt % to 80 wt %. The upper limit of the amount preferably is 75 wt %, more preferably 70 wt %, further more preferably 60 wt %, and most preferably 50 wt %. On the other hand, the lower limit of the amount preferably is 10 wt %, more preferably 15 wt %, further more preferably 20 wt %, and yet further more preferably 25 wt %.

The amount of the nitrile monomer in the polymerizable component containing the carboxy-containing monomer is not specifically restricted. However, the upper limit of the amount preferably is 95 wt %, more preferably 90 wt %, further more preferably 85 wt %, yet further more preferably 80 wt %, and most preferably 75 wt %. On the other hand, the lower limit of the amount preferably is 10 wt %, more preferably 15 wt %, further more preferably 20 wt %, yet further more preferably 25 wt %, and still further more preferably 30 wt %.

The polymerizable component preferably contains a (meth)acrylate monomer as the monomer component to control the expansion behavior of the resultant heat-expandable microspheres.

The amount of the (meth)acrylate monomer in the polymerizable component is not specifically restricted and preferable ranges from 0.1 wt % to 50 wt %. The upper limit of the amount preferably is 40 wt %, more preferably 30 wt %, further more preferably 20 wt %, and most preferably 15 wt %. On the other hand, the lower limit of the amount preferably is 0.3 wt %, more preferably 0.5 wt %, further more preferably 1 wt %, and most more preferably 2 wt %.

The polymerizable component preferably contains a (meth)acrylamide monomer as the monomer component to improve the heat resistance of the resultant microspheres.

The amount of the (meth)acrylamide monomer in the polymerizable component is not specifically restricted and preferably ranges from 0.1 wt % to 40 wt %. The upper limit of the amount preferably is 30 wt %, more preferably 20 wt %, further more preferably 15 wt %, and most preferably 10 wt %. On the other hand, the lower limit of the amount preferably is 0.3 wt %, more preferably 0.5 wt %, and further more preferably 1 wt %.

The polymerizable component can contain a crosslinking agent as mentioned above. The polymerizable component containing a crosslinking agent is preferable for improved gas-barrier effect of the resultant thermoplastic resin constituting the shell of heat-expandable microspheres to attain good compression recovery of the heat-expandable microspheres.

The crosslinking agent is not specifically restricted and includes, for example, alkane diol di(meth)acrylates, such as ethylene glycol di(meth)acrylate, 1,4-butanediol di(meth)acrylate, 1,6-hexanediol di(meth)acrylate, 1,9-nonanediol di(meth)acrylate, 1,10-decanediol di(meth)acrylate, neopentylglycol di(meth)acrylate, 3-methyl-1,5 pentanediol di(meth)acrylate and 2-methyl-1,8 octanediol di(meth)acrylate; polyalkylene glycol di(meth)acrylates, such as diethylene glycol di(meth)acrylate, triethylene glycol di(meth)acrylate, polyethylene glycol (200) di(meth)acrylate, polyethylene glycol (400) di(meth)acrylate, polyethylene glycol (600) di(meth)acrylate, polyethylene glycol (1000) di(meth)acrylate, dipropylene glycol di(meth)acrylate, tripropylene glycol di(meth)acrylate, polypropylene glycol (400) di(meth)acrylate, polypropylene glycol (700) di(meth)acrylate, polytetramethylene glycol di(meth)acrylate, polytetramethylene glycol (650) di(meth)acrylate and ethoxylated polypropylene glycol (700) di(meth)acrylate; and bifunctional, trifunctional, tetrafunctional or other polyfunctional cross-linkable monomers, such as ethoxylated bisphenol A di(meth)acrylate (with 2 to 30 moles of EO), propoxylated bisphenol A di(meth)acrylate, propoxylated ethoxylated bisphenol A di(meth)acrylate, glycerin di(meth)acrylate, 2-hydroxy-3-acryloyloxypropyl methacrylate, dimethylol-tricyclodecane di(meth)acrylate, divinylbenzene, ethoxylated glycerin triacrylate, 1,3,5-tri(meth)acryloylhexahydro-1,3,5-triazine, triaryl isocyanurate, pentaerythritol tri(meth)acrylate, trimethylolpropane tri(meth)acrylate, 1,2,4-trivinyl benzene, ditrimethylolpropane tetra(meth)acrylate, pentaerythritol tetra(meth)acrylate and dipentaerythritol hexa(meth)acrylate. One of or a combination of at least two of the crosslinking agents can be used.

The polymerizable component can contain no crosslinking agents. The amount of the crosslinking agent in the polymerizable component is not specifically restricted and preferably is 6 wt % or less. The polymerizable component containing 6 wt % or less of a crosslinking agent improves the expansion performance of the resultant heat-expandable microspheres. The upper limit of the amount of the crosslinking agent preferably is 5 wt %, more preferably 4 wt %, further more preferably 3 wt % and most preferably 2 wt %. On the other hand, the lower limit of the amount of the crosslinking agent preferably is 0 wt %, more preferably 0.05 wt %, further more preferably 0.1 wt % and yet further more preferably 0.2 wt %.

The blowing agent vaporizes by heating and the blowing agent encapsulated in the thermoplastic resin shell of heat-expandable microspheres makes the whole of a microsphere thermally expandable (a microsphere wholly expandable by heating).

The blowing agent encapsulated in the heat-expandable microspheres of the present invention essentially contains a blowing agent (a) having a specific heat ranging from 0.8 J/g·K to 2.0 J/g·K. A blowing agent (a) having a specific heat lower than 0.8 J/g·K does not vaporize at the right timing of softening of the shell during heating and causes poor expansion of the heat-expandable microspheres. On the other hand, a blowing agent (a) having a specific heat higher than 2.0 J/g·K causes poor thermoresponsiveness of the heat-expandable microspheres. The upper limit of the specific heat preferably is 1.9 J/g·K, more preferably 1.8 J/g·K, further more preferably 1.7 J/g·K, yet further more preferably 1.6 J/g·K, and most preferably 1.5 J/g·K. On the other hand, the lower limit of the specific heat preferably is 0.9 J/g·K, more preferably 0.95 J/g·K, further more preferably 1.0 J/g·K, and yet further more preferably 1.05 J/g·K. The specific heat of the blowing agent (a) is measured by the method in the Examples.

The blowing agent (a) includes, for example, fluorine-containing compounds. The blowing agent (a) containing a fluorine-containing compound is preferable for attaining the effect of the present invention

The fluorine-containing compounds include, for example, hydrofluoroethers, such as CH₃OCH₂CF₂CHF₂, CH₃OCH₂CF₂CF₃, CH₃OCF₂CHFCF₃, CH₃OCF₂CF₂CF₃, CHF₂OCH₂CF₂CF₃, CH₃OCH(CF₃)₂, CH₃OCF(CF₃)₂, CF₃CH₂OCF₂CH₂F, and CF₃CH₂OCF₂CHF₂; fluoroketones, such as CF₃CF₂COCF(CF₃)CF₃; perfluoroethers, such as CF₃OCF₃, and CF₃OCF₂CF₃; hydrofluoroolefins, such as CF₃CHCHCF₃; and hydrochlorofluoroorefins, such as CF₃CHCHCl. One of or a combination to at least two of the blowing agents (a) can be used.

The blowing agent (a) preferably contains at least one substance selected from fluoroketones and hydrofluoroethers to attain the effect of the present invention. The total amount of the fluoroketones and hydrofluoroethers contained in the blowing agent (a) is not specifically restricted and preferably is at least 50 wt %, more preferably at least 75 wt %, further more preferably at least 90 wt %, yet further more preferably at least 95 wt %, and most preferably 100 wt %.

The amount of the blowing agent (a) in the blowing agent contained in the heat-expandable microspheres is not specifically restricted and preferably is at least 50 wt %. The amount of the blowing agent (a) higher than 50 wt % improves the expansion performance of the microspheres in short time heating. The amount preferably ranges from 75 wt % to 100 wt %, more preferably from 90 wt % to 100 wt %, further more preferably from 95 wt % to 100 wt %, and most preferably be 100 wt %.

The blowing agent contained in the heat-expandable microspheres of the present invention can contain a blowing agent other than the blowing agent (a) (hereinafter referred to as other blowing agents).

Other blowing agents include, for example, C₁-C₁₃ hydrocarbons such as methane, ethane, propane, (iso)butane, (iso)pentane, (iso)hexane, (iso)heptane, (iso)octane, (iso)nonane, (iso)decane, (iso)undecane, (iso)dodecane and (iso)tridecane; hydrocarbons having a carbon number greater than 13 and not greater than 20, such as (iso)hexadecane and (iso)eicosane; hydrocarbons from petroleum fractions such as pseudocumene, petroleum ether, and normal paraffins and isoparaffins having an initial boiling point ranging from 150° C. to 260° C. and/or being distilled at a temperature ranging from 70° C. to 360° C.; silanes having C₁-C₅ alkyl groups, such as tetramethyl silane, trimethylethyl silane, trimethylisopropyl silane and trimethyl-n-propyl silane; and compounds which thermally decompose to generate gases, such as azodicarbonamide, N,N′-dinitrosopentamethylenetetramine and 4,4′-oxybis(benzenesulfonyl hydrazide). One of or a combination of at least two of other blowing agents mentioned above can be used.

The specific heat of the blowing agent is not specifically restricted and preferably ranges from 0.8 J/g·K to 2.0 J/g·K. A blowing agent having a specific heat of at least 0.8 J/g·K improves the expansion performance of the heat-expandable microspheres because the shell of the microspheres softens in heating process at nearly the same time as the vaporization of the blowing agent. On the other hand, a blowing agent having a specific heat not higher than 2.0 J/g·K improves the thermoresponsiveness of the heat-expandable microspheres. The upper limit of the specific heat preferably is 1.9 J/g·K, more preferably 1.8 J/g·K, further more preferably 1.7 J/g·K, yet further more preferably 1.6 J/g·K, and most preferably 1.5 J/g·K. On the other hand, the lower limit of the specific heat preferably is 0.9 J/g·K, more preferably 0.95 J/g·K, further more preferably 1.0 J/g·K, and yet further more preferably 1.05 J/g·K. The specific heat of the blowing agent is measured by the method described in the Examples.

The vapor pressure of the blowing agent at 150° C. is not specifically restricted and preferably ranges from 0.01 MPa to 50 MPa to improve the expansion performance of the heat-expandable microspheres. The upper limit of the vapor pressure preferably is (1) 40 MPa, (2) 30 MPa, (3) 20 MPa, (4) 10 MPa, (6) 5 MPa, (7) 3 MPa or (8) 2 MPa in this order (where greater number in the parentheses indicates more preferable vapor pressure). On the other hand, the lower limit of the vapor pressure preferably is (1) 0.05 MPa, (2) 0.1 MPa, (3) 0.2 MPa, (4) 0.3 MPa, (5) 0.5 MPa, (6) 0.8 MPa or (7) 1 MPa in this order (where greater number in the parentheses indicates more preferable vapor pressure).

The amount of the blowing agent encapsulated in the heat-expandable microspheres (hereinafter sometimes referred to as the encapsulation ratio of the blowing agent) is defined as the weight percentage of the blowing agent to the weight of the heat-expandable microspheres.

The encapsulation ratio of the blowing agent is not specifically restricted and preferably ranges from 1 wt % to 55 wt %. The encapsulation ratio within the range attains high internal pressure of the heat-expandable microspheres in heating and contributes to high expansion of the heat-expandable microspheres. The upper limit of the encapsulation ratio preferably is 50 wt %, more preferably 45 wt %, further more preferably 40 wt %, and most preferably 35 wt %. On the other hand, the lower limit of the encapsulation ratio preferably is 5 wt %, more preferably 10 wt %, and further more preferably 15 wt %. The encapsulation ratio of the blowing agent is measured by the method described in the Examples.

The expansion initiation temperature (Tₛ) of the heat-expandable microspheres is not specifically restricted and preferably ranges from 70° C. to 250° C. for attaining the effect of the present invention. The upper limit of the temperature preferably is 230° C., more preferably 200° C., further more preferably 180° C., and most preferably 160° C. On the other hand the lower limit of the temperature preferably is 80° C., more preferably 90° C., and further more preferably 100° C. The expansion initiation temperature (Tₛ) of the heat-expandable microspheres is measured by the method described in the Examples.

The maximum expansion temperature (Tₘₐₓ) of the heat-expandable microspheres is not specifically restricted, and preferably ranges from 95° C. to 300° C. for attaining the effect of the present invention. The upper limit of the temperature preferably is 280° C., more preferably 260° C., further more preferably 240° C., and most preferably 200° C. On the other hand the lower limit of the temperature preferably is 100° C., more preferably 105° C., further more preferably 110° C., and most preferably 120° C. The maximum expansion temperature (Tₘₐₓ) of the heat-expandable microspheres is measured by the method described in the Examples.

The specific heat of the heat-expandable microspheres of the present invention is not specifically restricted and preferably ranges from 1.05 J/g·K to 1.5 J/g·K. The heat-expandable microspheres having a specific heat within the range exhibits high expansion performance and highly thermoresponsive expansion behavior in short heating time. The upper limit of the specific heat preferably is 1.45 J/g·K, more preferably 1.40 J/g·K, and further more preferably 1.35 J/g·K. On the other hand, the lower limit of the specific heat preferably is 1.10 J/g·K, more preferably 1.15 J/g·K, and further more preferably 1.20 J/g·K. The specific heat of the heat-expandable microspheres is measured by the method described in the Examples.

The 50-% cumulative volume particle size (A50, hereinafter simply referred to as A50 sometimes) of the heat-expandable microspheres of the present invention is not specifically restricted and preferably ranges from 1 μm to 200 μm. The heat-expandable microspheres having a 50-% cumulative volume particle size within the range have a shell with sufficient thickness and gas-barrier effect and have improved expansion performance. The upper limit of the 50-% cumulative volume particle size preferably is 100 μm, more preferably 50 μm, and further more preferably 45 μm. On the other hand, the lower limit of the 50-% cumulative volume particle size preferably is 3 μm, more preferably 5 μm, further more preferably 7 μm, and most preferably 10 μm. The A50 is measured by the method described in the Examples.

The ratio of the 50-% cumulative volume particle size (A50) to the 10-% cumulative volume particle size (A10, hereinafter simply referred to as A10 sometimes), A50/A10, of the heat-expandable microspheres of the present invention is not specifically restricted and preferably is at least 1.1. The A50/A10 of at least 1.1 optimizes the number of fine heat-expandable microspheres and the heat-expandable microspheres exhibit highly thermoresponsive expansion behavior. The upper limit of the A50/A10 preferably is 7, more preferably 6.5, further more preferably 6 and most preferably 5. On the other hand, the lower limit of the A50/A10 preferably is 1.2, more preferably 1.3, further more preferably 1.4 and most preferably 1.5. The A10 is measured by the method described in the Examples.

The ratio of the 90-% cumulative volume particle size (A90, hereinafter simply referred to as A90 sometimes) to the 50-% cumulative volume particle size (A50), A90/A50, of the heat-expandable microspheres of the present invention is not specifically restricted and preferably ranges from 1.1 to 5.5. The A90/A50 within the range optimizes the number of coarse heat-expandable microspheres and the heat-expandable microspheres expand uniformly in short time heating. The upper limit of the A90/A50 preferably is 5, more preferably 4.5, further more preferably 4 and most preferably 3.5. On the other hand, the lower limit of the A90/A50 preferably is 1.15, more preferably 1.2, further more preferably 1.25 and most preferably 1.3. The A90 is measured by the method described in the Examples.

### Production of Heat-Expandable Microspheres

The procedure for producing heat-expandable microspheres of the present invention includes the process of dispersing an oily mixture which contains a polymerizable component, a blowing agent and a polymerization initiator in an aqueous dispersion medium and polymerizing the polymerizable component (hereinafter sometimes referred to as polymerization process).

The polymerization initiator is not specifically restricted, and includes peroxides and azo compounds which are generally used.

The peroxides include, for example, peroxidicarbonates, such as diisopropyl peroxydicarbonate, di-sec-butyl peroxydicarbonate, di-2-ethylhexyl peroxydicarbonate and dibenzyl peroxydicarbonate; diacyl peroxides, such as dilauroyl peroxide and dibenzoyl peroxide; ketone peroxides, such as methyl ethyl ketone peroxide and cyclohexanone peroxide; peroxy ketals, such as 2,2-bis(t-butylperoxy) butane; hydroperoxides, such as cumene hydroperoxide and t-butyl hydroperoxide; dialkyl peroxides, such as dicumyl peroxide and di-t-butyl peroxide; and peroxyesters, such as t-hexyl peroxypivalate and t-butyl peroxyisobutylate.

The azo compound includes, for example, 2,2′-azobis(4-methoxy-2,4-dimethyl valeronitrile), 2,2′-azobisisobutylonitrile, 2,2′-azobis(2,4-dimethyl valeronitrile), 2,2′-azobis(2-methyl propionate), 2,2′-azobis(2-methyl butylonitrile) and 1,1′-azobis(cyclohexane-1-carbonitrile).

The amount of the polymerization initiator is not specifically restricted and preferably ranges from 0.05 wt % to 10 wt %, more preferably from 0.1 wt % to 8 wt %, and most preferably from 0.2 wt % to 5 wt % of the polymerizable component. The amount of the polymerization initiator lower than 0.05 wt % may leave some of the polymerizable component unpolymerized and such unpolymerized component may agglomerate the complete heat-expandable microspheres to inhibit the production of uniform microspheres. The amount of the polymerization initiator higher than 10 wt % may cause poor heat resistance of the resultant heat-expandable microspheres.

The procedure for producing the heat-expandable microspheres of the present invention includes the steps of preparing an aqueous suspension by dispersing an oily mixture in an aqueous dispersion medium and polymerizing a polymerizable component. The aqueous dispersion medium contains water, such as ion-exchanged water, as the main component, and the oily mixture is dispersed therein. The aqueous dispersion medium can further contain alcohols, such as methanol, ethanol and propanol, and hydrophilic organic solvents, such as acetone. The hydrophilic property mentioned in the present invention means the property of a substance optionally miscible in water. The amount of the aqueous dispersion medium used in the process is not specifically restricted, and preferably ranges from 100 parts by weight to 1000 parts by weight to 100 parts by weight of the polymerizable component.

The aqueous dispersion medium can further contain an electrolyte, such as sodium chloride, magnesium chloride, calcium chloride, sodium sulfate, magnesium sulfate, ammonium sulfate and sodium carbonate. One of or a combination of at least two of these electrolytes can be used. The amount of the electrolyte is not specifically restricted, and preferably ranges from 0.1 parts by weight to 50 parts by weight to 100 parts by weight of the aqueous dispersion medium.

The aqueous dispersion medium can contain at least one water-soluble compound selected from among potassium dichromate, alkali metal nitrite salts, metal (III) halides, boric acid, water-soluble ascorbic acids, water-soluble polyphenols, water-soluble vitamin Bs, water-soluble phosphonic acids (phosphonate salts), and water-soluble 1,1-substitution compounds having a carbon atom bonded with a hetero atom and with a hydrophilic functional group selected from hydroxyl group, carboxylic acid (carboxylate salt) groups and phosphonic acid (phosphonate salt) groups. The term “water-soluble” in the present invention means that at least 1 g of a substance is soluble in 100 g of water.

The amount of the water-soluble compound contained in the aqueous dispersion medium is not specifically restricted, and preferably ranges from 0.0001 part by weight to 1.0 part by weight to 100 parts by weight of the polymerizable component, more preferably from 0.0003 parts by weight to 0.1 part by weight, and most preferably from 0.001 part by weight to 0.05 parts by weight. Excessively small amount of the water-soluble compound may result in insufficient effect by the water-soluble compound. On the other hand, excessive amount of the water-soluble compound may decrease the polymerization rate or increase the amount of the polymerizable component remaining as the residue after the polymerization.

The aqueous dispersion medium can contain a dispersion stabilizer and dispersion stabilizing auxiliary in addition to the electrolytes and water-soluble compounds.

The dispersion stabilizer is not specifically restricted, and includes, for example, calcium triphosphate, magnesium pyrophosphate and calcium pyrophosphate produced by double reaction, colloidal silica, alumina sol and magnesium hydroxide. One of or a combination of at least two of those dispersion stabilizers can be used. The amount of the dispersion stabilizer preferably ranges from 0.1 part by weight to 30 parts by weight to 100 parts by weight of the polymerizable component and more preferably from 0.5 parts by weight to 20 parts by weight.

The dispersion stabilizing auxiliary is not specifically restricted, and includes, for example, polymeric dispersion stabilizing auxiliaries, and surfactants, such as cationic surfactants, anionic surfactants, amphoteric surfactants and nonionic surfactants. One of or a combination of at least two of those dispersion stabilizing auxiliaries can be used.

The aqueous dispersion medium is prepared, for example, by adding water-soluble compounds and optionally adding dispersion stabilizers and/or dispersion stabilizing auxiliaries to water (deionized water). The pH of the aqueous dispersion medium for polymerization is adjusted according to the water-soluble compounds, dispersion stabilizers and dispersion stabilizing auxiliaries.

For producing the heat-expandable microspheres of the present invention, the polymerizable component can be polymerized in the presence of sodium hydroxide and zinc chloride.

In the production process of the heat-expandable microspheres of the present invention, the oily mixture is dispersed into oil globules of the predetermined particle size in the aqueous dispersion medium.

The methods for dispersing and suspending the oily mixture include generally known dispersion methods, such as agitation with a Homo-mixer (for example, a device manufactured by Primix Corporation), dispersion with a static dispersing apparatus such as a Static mixer (for example, a device manufactured by Noritake Engineering Co., Ltd.), membrane emulsification technique and ultrasonic dispersion.

Then suspension polymerization is started by heating the dispersion in which the oily mixture is dispersed into oil globules in the aqueous dispersion medium. During the polymerization reaction, the dispersion should preferably be agitated gently to prevent floating of oil globules and sedimentation of polymerized heat-expandable microspheres.

The polymerization temperature can be set optionally depending on the type of the polymerization initiator, and preferably is controlled within the range from 30° C. to 100° C. and more preferably from 40° C. to 90° C. The polymerization temperature preferably is maintained for about 1 to 20 hours. The initial pressure for the polymerization is not specifically restricted, and preferably is controlled within the range from 0 MPa to 5 MPa in gauge pressure and more preferably from 0.1 MPa to 3 MPa.

After the polymerization, a metal salt can be added to the slurry (a suspension of heat-expandable microspheres) to form ionic crosslink with the carboxyl groups of the heat-expandable microspheres or the surface of the heat-expandable microspheres can be treated with a metal-containing organic compound.

The metal salt preferably is a salt of a metal cation having at least two valences, such as Al, Ca, Mg, Fe, Ti and Cu. A water-soluble metal salt is preferable for easy addition, though a water-insoluble metal salt can be used. The metal-containing organic compound preferably is water-soluble for efficient surface treatment and an organic compound containing a metal in the third to twelfth periods of the periodic table is preferable for improved heat resistance of the heat-expandable microspheres.

The resultant slurry is filtered with a centrifugal separator, press filter or suction extractor to be processed into wet powder with a water content ranging from 10 wt % to 50 wt %, preferably from 15 wt % to 45 wt % and more preferably from 20 wt % to 40 wt %. The wet powder is dried in a tray drier, indirect heating oven, fluidized bed dryer, vacuum dryer, vibration dryer or flash dryer to be prepared into dry powder. The moisture content of the dry powder preferably is not greater than 8 wt % and more preferably not greater than 5 wt %.

The resultant wet powder or dry powder can be washed with water and/or redispersed in water and then filtered again before the drying step for the purpose of decreasing the content of the ionic substances. The slurry can also be dried with a spray dryer or fluidized bed dryer to be processed into dry powder. The selection of the wet powder and dry powder depends on the application of the powders.

### Hollow Particles

The hollow particles of the present invention are manufactured by thermally expanding the heat-expandable microspheres mentioned above and exhibit excellent material properties when contained in a composition or formed product.

The hollow particles of the present invention are manufactured by thermally expanding the heat-expandable microspheres composed of a thermoplastic resin shell, which is the polymer of a certain polymerizable component, and a blowing agent encapsulated therein. The hollow particles are lightweight and resistant to collapse.

The hollow particles of the present invention are manufactured by thermally expanding the heat-expandable microspheres mentioned above at a temperature preferably ranging from 70° C. to 450° C. The thermal expansion process is not specifically restricted and either dry thermal expansion or wet thermal expansion can be employed. An example of the dry thermal expansion is the method disclosed in Japanese Patent Application Publication 2006-213930, specifically, the internal injection method. Another example of the dry thermal expansion is the method disclosed in Japanese Patent Application Publication 2006-96963. An example of the wet thermal expansion is the method disclosed in Japanese Patent Application Publication 1987-201231.

The mean volume particle size of the hollow particles of the present invention can be freely designed according to their application. The mean volume particle size of the hollow particles is not specifically restricted and preferably ranges from 3 μm to 1000 μm. The upper limit of the mean volume particle size preferably is 500 μm and more preferably 300 μm. On the other hand, the lower limit of the mean volume particle size preferably is 5 μm, more preferably 10 μm, and further more preferably 20 μm. The mean volume particle size mentioned here is the 50-% cumulative volume particle size measured by laser diffractometry.

The true specific gravity of the hollow particles of the present invention is not specifically restricted and preferably ranges from 0.001 to 0.60 to attain the effect of the present invention. The hollow particles having a true specific gravity within the range are resistant to collapse. The upper limit of the true specific gravity preferably is 0.50, more preferably 0.40, further more preferably 0.30, and most preferably 0.20. On the other hand, the lower limit of the true specific gravity preferably is 0.0015, and more preferably 0.002. The true specific gravity of the hollow particles is measured by the method described in the Examples.

### Fine-Particle-Coated Hollow Particles

As shown in FIG. 2, the fine-particle-coated hollow particles of the present invention contain the fine-particle (4 and 5) coating the outer surface of the shell (2) of the hollow particles (1).

The coating mentioned herein means that the fine-particle (4 and 5) are in a state of adhesion (the state of the fine-particle 4 in FIG. 2) on the outer surface of the shell 2 of hollow particles, or in a state of fixation (the state of the fine-particle 5 in FIG. 2) in a dent on the outer surface of the shell as the result of the particulate filler pushing into the thermoplastic shell melted by heating. The shape of the particulate material can be infinite or spherical.

The fine-particle coating the hollow particles prevents scattering of the hollow particles to improve their handling property and improves their dispersibility in a base component, such as binders and resins.

The fine-particle can be selected from various materials including both inorganic and organic materials. The shape of the fine-particle includes spherical, needle-like and plate-like shapes.

The inorganic compounds constituting the fine-particle are not specifically restricted, and include, for example, wollastonite, sericite, kaolin, mica, clay, talc, bentonite, aluminum silicate, pyrophyllite, montmorillonite, calcium silicate, calcium carbonate, magnesium carbonate, dolomite, calcium sulfate, barium sulfate, glass flake, boron nitride, silicon carbide, silica, alumina, isinglass, titanium dioxide, zinc oxide, magnesium oxide, hydrotalcite, carbon black, molybdenum disulfide, tungsten disulfide, ceramic beads, glass beads, crystal beads and glass microballoons.

The organic compounds constituting the=fine-particle are not specifically restricted, and include, for example, sodium carboxymethyl cellulose, hydroxyethyl cellulose, methyl cellulose, ethyl cellulose, nitro cellulose, hydroxypropyl cellulose, sodium alginate, polyvinyl alcohol, polyvinyl pyrolidone, sodium polyacrylate, carboxyvinyl polymer, polyvinyl methyl ether, magnesium stearate, calcium stearate, zinc stearate, polyethylene wax, lauric amide, myristic amide, palmitic amide, stearic amide, hydrogenated castor oil, (meth)acrylic resin, polyamide resin, silicone resin, urethane resin, polyethylene resin, polypropylene resin and fluorine resin.

The inorganic and organic compounds constituting the fine-particle can be surface-treated with a surface-treatment agent, such as a silane coupling agent, paraffin wax, fatty acid, resin acid, urethane compound and fatty acid ester, or can not be surface-treated.

The mean volume particle size of the fine-particle preferably ranges from 0.001 μm to 30 μm, more preferably from 0.005 μm to 25 μm, and most preferably from 0.01 μm to 20 μm. The mean volume particle size of the fine-particle mentioned herein is the 50-% cumulative volume particle size determined by laser diffractometry.

The ratio of the mean volume particle size of the fine-particle to the mean volume particle size of the hollow particles (the mean volume particle size of the fine-particle/the mean volume particle size of the hollow particles) preferably is not greater than 1 for sufficiently coating the hollow particles with the fine-particle, more preferably not greater than 0.1 and further more preferably not greater than 0.05.

The percentage of the fine-particles in the fine-particle-coated hollow particles is not specifically restricted, and preferably is not higher than 95 wt %, more preferably not higher than 90 wt %, further more preferably not higher than 85 wt % and most preferably not higher than 80 wt %. The percentage of the fine-particle higher than 95 wt % can result in higher amount of the fine-particle-coated hollow particles required to be added to a composition and lead to increased cost of the fine-particle-coated hollow particles. The lower limit of the percentage of the particulate material preferably is 10 wt %, more preferably 20 wt %, further more preferably 30 wt %, and most preferably 40 wt %.

The true specific gravity of the fine-particle-coated hollow particles is not specifically restricted and preferably ranges from 0.03 to 0.60. The fine-particle-coated hollow particles having a true specific gravity of at least 0.03 have sufficiently thick shell which is resistant to collapse. On the other hand, the fine-particle-coated hollow particles having a true specific gravity of 0.60 or less attain sufficient effect of decreasing the specific gravity of the resultant composition or formed product and sufficiently maintain the properties of the composition and formed product when the composition containing the fine-particle-coated hollow particles is prepared to manufacture the formed product. The upper limit of the true specific gravity preferably is 0.40, more preferably 0.30 and further more preferably 0.20. On the other hand, the lower limit of the true specific gravity preferably is 0.07, and more preferably 0.10.

The fine-particle-coated hollow particles are prepared, for example, by thermally expanding fine-particle-coated heat-expandable microspheres. The preferable process for manufacturing the fine-particle-coated hollow particles include the step of mixing heat-expandable microspheres and fine-particles (mixing step) and the step of heating the mixture prepared in the mixing step at a temperature higher than the softening temperature mentioned above to expand the heat-expandable microspheres and coat the outer surface of the resultant hollow particles with the fine-particles (coating step).

The heat-expandable microspheres and fine-particle material are mixed in the mixing step.

In the mixing step, the amount of the fine-particle material in the total amount of the heat-expandable microspheres and the fine-particle material is not specifically restricted, and preferably is not higher than 95 wt %, more preferably not higher than 90 wt %, further more preferably not higher than 85 wt % and most preferably not higher than 80 wt %. The fine-particle-coated hollow particles prepared with 95 wt % or lower amount of the particulate material are lightweight and attain sufficient effect of decreasing the specific gravity of the resultant composition or product.

The device used to mix the heat-expandable microspheres and fine-particle material in the mixing step is not specifically restricted, and a quite simple device, such as a combination of a vessel and stirring paddle, can be used. A common type of powder mixer which shakes and agitates powder materials can be used.

Such powder mixers include a ribbon mixer and vertical screw mixer which can shake and agitate or agitate powder materials. Recently available are high-efficiency multifunctional powder mixers manufactured by combining a plurality of agitation devices, such as Super Mixer (manufactured by KAWATA MFG Co., Ltd.), High Speed Mixer (manufactured by Fukae Co., Ltd.), New-Gra Machine (manufactured by Seishin Enterprise Co., Ltd.) and SV Mixer (manufactured by Kobelco Eco-Solutions Co., Ltd.), and those mixers can be employed.

In the coating step, the mixture of the heat-expandable microspheres and fine-particle material prepared in the mixing step is heated at a temperature higher than the softening point of the thermoplastic resin constituting the shell of the microspheres, and the heat-expandable microspheres are expanded and simultaneously coated with the fine-particle material on the outer surface of their shell.

The heat-expandable microspheres can be heated by a commonly used mixer dryer with contact heating system or direct heating system. The function of the mixer dryer is not specifically restricted, and the mixer dryer should preferably have the function of dispersing and mixing powder material under a controlled temperature, and optionally have a decompression device and a cooling device for accelerating the drying operation. The heating device is not specifically restricted, and includes, for example, Loedige Mixer (manufactured by Matsubo Corporation) and Solidaire (manufactured by Hosokawa Micron Corporation).

The heating temperature is set at the optimum expansion temperature for the heat-expandable microspheres to be heated, and the temperature preferably ranges from 70° C. to 250° C., more preferably from 80° C. to 230° C. and further more preferably from 90° C. to 220° C.

### Compositions and Formed Products

The composition of the present invention contains a base component and at least one selected from the group consisting of the heat-expandable microspheres, the hollow particles and the fine-particle-coated hollow particles mentioned above.

The base component is not specifically restricted, and includes rubbers, such as natural rubbers, butyl rubber, silicone rubber and ethylene-propylene-diene rubber (EPDM); thermosetting resins, such as unsaturated polyester resins, epoxy resins and phenolic resins; waxes, such as polyethylene waxes and paraffin waxes; thermoplastic resins, such as ethylene-vinyl acetate copolymer (EVA), ionomers, polyethylene, polypropylene, polyvinyl chloride (PVC), acrylic resin, thermoplastic polyurethane, acrylonitrile-styrene copolymer (AS resin), acrylonitrile-butadiene-styrene copolymer (ABS resin), polystyrene (PS), polyamide resin (nylon 6, nylon 66, etc.), polycarbonate, polyethylene terephthalate (PET), polybutylene terephthalate (PBT), polyacetal (POM) and polyphenylene sulfide (PPS); thermoplastic elastomers, such as olefin elastomers and styrene elastomers; fluorine-containing resins, such as polyvinylidene fluoride, polytetrafluoroethylene, vinylidene fluoride-hexafluoropropylene-tetrafluoroethylene copolymer, vinylidene fluoride-hexafluoropropylene copolymer, vinylidene fluoride-tetrafluoroethylene copolymer, hexafluoropropylene-tetrafluoroethylene copolymer, and ethylene-tetrafluoroethylene; bioplastics, such as polylactic acid (PLA), cellulose acetate, PBS, PHA and starch resins; sealing materials, such as silicones, modified silicones, polysulfides, modified polysulfides, urethanes, acrylates, polyisobutylenes and butyl rubbers; liquid ingredients, such as the emulsion or plastisol of urethane polymers, ethylene-vinyl acetate copolymers, vinyl chloride polymers and acrylate polymers; inorganic materials, such as cement, mortar and cordierite; and organic fibers, such as cellulose fiber, kenaf, bran, aramid fiber, phenol fiber, polyester fiber, acrylic fiber, polyolefin fiber including polyethylene and polypropylene, polyvinyl alcohol fiber and rayon fiber. The base components can be diluted, dissolved or dispersed in water or organic solvents. One of or a combination of at least two of those base components can be used.

The composition of the present invention is prepared by mixing the base component and at least one selected from the heat-expandable microspheres, hollow particles and fine-particle-coated hollow particles. The composition of the present invention can also be prepared by mixing another base component with the composition prepared by mixing the base component and at least one selected from the heat-expandable microspheres, hollow particles and fine-particle-coated hollow particles.

The composition of the present invention can contain optional ingredients other than the base component and at least one selected from the heat-expandable microspheres, hollow particles and fine-particle-coated hollow particles, according to the application of the composition.

The total content of the heat-expandable microspheres, hollow particles and fine-particle-coated hollow particles in the composition of the present invention is not specifically restricted and preferably ranges from 0.05 to 350 parts by weight to 100 parts by weight of the base component. The total content of at least 0.01 parts by weight makes the composition to be manufactured into sufficiently lightweight formed product. The total content of 350 parts by weight or less improves the evenness of the dispersed state of the microspheres which is at least one selected from the heat-expandable microspheres, hollow particles and fine-particle-coated hollow particles. The upper limit of the total content preferably is 300 parts by weight, more preferably 200 parts by weight, further more preferably 150 parts by weight, and most preferably 100 parts by weight. On the other hand, the lower limit of the total content preferably is 0.1 parts by weight, more preferably 0.2 parts by weight, further more preferably 0.5 parts by weight, and most preferably 1 part by weight.

The process for preparing the composition of the present invention is not specifically restricted and any of the known processes can be employed. The process includes, for example, the processes of mechanical homogenization with a homogenizing mixer, static dispersing apparatus, Henschel mixer, tumbler mixer, planetary mixer, kneader, roller kneader, mixing roller, mixer, single screw extruder, twin screw extruder, and multi-screw extruder.

The composition of the present invention includes, for example, a rubber composition, molding composition, paint composition, clay composition, adhesive composition and powder composition.

The composition of the present invention preferably is a liquid composition or paste composition (hereinafter sometimes referred to as liquid or paste composition). The liquid or paste composition includes, for example, compositions containing vinyl chloride resin, acrylate resin, polyurethane resin, polyester resin, melamine resin, epoxy resin, ethylene-vinyl acetate resin (EVA), olefin resin including polyethylene, fluorine resin including ethylene-tetrafluoroethylene, and rubbers including natural rubber and styrene rubber. The liquid or paste composition also includes a plastisol containing a plasticizer, a resin emulsion containing a liquid dispersion medium, and a composition mixed with a liquid, such as latex. The plastisol, resin emulsion and liquid composition containing latex can be subjected to heating at high temperature in short time for improved manufacturing efficiency of formed products, and the composition mentioned above enables the manufacture of lightweight formed products resistant to collapse.

The liquid or paste composition of the present invention preferably is a paint composition or adhesive composition.

The paint composition of the present invention is applicable for automotive paints, aircraft paints, train paints, paints for electric appliance bodies, exterior coating, interior coating, and roof coating.

The adhesive composition of the present invention is applicable for automotive adhesives, aircraft adhesives, train adhesives, adhesives for electric appliances, and adhesives for buildings.

The plasticizer includes, for example, phthalate plasticizers, such as dioctyl phthalate, diisobutyl phthalate and diisononyl phthalate; phosphate plasticizers, such as alkyldiphenyl phosphate; chlorinated aliphatic esters; chlorinated paraffins; low-molecular-weight epoxy; low-molecular-weight polyester; adipate plasticizers, such as dioctyl adipate; and cyclohexane dicarboxylate plasticizers, such as diisononyl cyclohexane dicarboxylate.

The liquid dispersion medium includes, for example, water, mineral spirit, methanol, ethyl acetate, toluene, methyl-ethyl ketone, dimethylformamide, dimethylacetamide, N-methylpyrrolidone, and cyclohexanone.

The composition of the present invention can optionally contain a filler, colorant, high-boiling-point organic solvent and adhesive.

The filler includes, for example, calcium carbonate, talc, titanium oxide, zinc flower, clay, kaolin, silica and alumina.

The colorant includes, for example, carbon black and titanium oxide.

The adhesive includes, for example, a mixture of at least one selected from polyamines, polyamides and polyols and a polyisocyanate prepolymer the terminal NCO group of which is blocked with a proper blocking agent, such as oxime and lactam.

The composition of the present invention is used as the master batch for foam molding if the composition contains the heat-expandable microspheres and the base component including a chemical compound and/or thermoplastic resin having a melting point lower than the expansion-initiation temperature of the heat-expandable microspheres (for example, waxes, such as polyethylene waxes and paraffin waxes; thermoplastic resins, such as ethylene-vinyl acetate copolymer (EVA), polyethylene, modified polyethylene, polypropylene, modified polypropylene, modified polyolefin, polyvinyl chloride (PVC), acrylate resin, thermoplastic polyurethane, acrylonitrile-styrene copolymer (AS resin), acrylonitrile-butadiene-styrene copolymer (ABS resin), polystyrene (PS), polycarbonate, polyethylene terephthalate (PET) and polybutylene terephthalate (PBT); ionomer resins, such as ethylene ionomers, urethane ionomers, styrene ionomers and fluorine ionomers; thermoplastic elastomers, such as olefin elastomers, styrene elastomers and urethane elastomers; and rubbers, such as natural rubber, isoprene rubber (IR), butadiene rubber (BR), styrene-butadiene rubber (SBR), chloroprene rubber (CR), nitrile rubber (NBR), butyl rubber, silicone rubber, acrylic rubber, urethane rubber, fluorine rubber and ethylene-propylene-diene rubber (EPDM)). The master batch composition for foam molding is preferably employed in injection molding, extrusion molding and press molding for the purpose of introducing bubbles into molded articles.

The formed product of the present invention is manufactured by forming the composition mentioned above.

The formed product of the present invention includes, for example, coatings and molded products.

The formed product of the present invention has improved properties, such as lightweight property, porosity, sound absorbency, thermal insulation property, low thermal conductivity, permittivity-decreasing property, design potential, shock absorbing performance, strength, and chipping resistance. Furthermore, the formed product of the present invention maintains stable shape against sink marks or distortion and has high dimensional stability.

### EXAMPLES

Examples of the heat-expandable microspheres of the present invention are specifically described below. The present invention is not restricted within the scope of those Examples. In the following Examples and Comparative Examples, “part(s)” means “part(s) by weight” and “%” means “wt %” unless otherwise specified.

The properties of the heat-expandable microspheres mentioned in the following Examples and Comparative Examples were measured by the procedure described below to evaluate the heat-expandable microspheres. The heat-expandable microspheres can sometimes simply referred to as “microspheres”.

### Particle Sizes, A50, A10 and A90, of Heat-Expandable Microspheres

A Microtrac particle size analyzer (9320-HRA, manufactured by Nikkiso Co., Ltd.) was employed as the device for the determination of the D50, D10 and D90 of the cumulative volume particle size, which were respectively defined as A50, A10, and A90.

### Moisture Content of Heat-Expandable Microspheres (C_{w})

The moisture content of a sample of microspheres was determined with a Karl Fischer moisture meter (MKA-510N, manufactured by Kyoto Electronics Manufacturing Co., Ltd.). The moisture content (wt %) of the heat-expandable microspheres was represented by C_{w}.

### Encapsulation Ratio of a Blowing Agent (Cᵣ) in Heat-Expandable Microspheres

One gram of a sample of heat-expandable microspheres, the moisture content of which had been adjusted to 2 wt % or less, was placed in a stainless-steel evaporating dish 15 mm deep and 80 mm in diameter, and weighed (WA1 [g]). Then 30 mL of acetonitrile was added to disperse the microspheres evenly. After being left for 24 hours at room temperature, the sample was dried under reduced pressure at 130° C. for 2 hours, and the dry weight (WA2 [g]) was determined.

The encapsulation ratio of the blowing agent (Cᵣ) in the heat-expandable microspheres was calculated by the following formula.

$${C}_{r} ( wt \% ) = 100 \times \{ 100 \times ( WA 1 - WA 2 ) / 1. \cdot {C}_{w} \} / ( 100 \cdot {C}_{w} ) \qquad ( 1 )$$

where the moisture content of the heat-expandable microspheres, C_{w}, was measured by the method mentioned above.
   Expansion-Initiation Temperature (Tₛ) and the Maximum Expansion Temperature (Tₘₐₓ) of Heat-Expandable Microspheres

The expansion-initiation temperature and maximum expansion temperature were determined with a DMA (DMA Q800, manufactured by TA Instruments). In an aluminum cup 4.8 mm deep and 6.0 mm in diameter (5.65 mm in inner diameter), 0.5 mg of a sample of dried heat-expandable microspheres was placed, and the sample was covered with an aluminum lid (5.6 mm in diameter and 0.1 mm thick) to prepare a test sample. The test sample was set on the device and subjected to the pressure of 0.01 N with the compression unit of the device, and the height of the sample was measured. The sample was then heated by elevating the temperature at the rate of 10° C./min from 20° C. to 300° C., being subjected to the pressure of 0.01 N with the compression unit, and the change in the height of the sample was measured. The temperature at which the height started to increase was determined as the expansion-initiation temperature (Tₛ [° C.]) of the heat-expandable microspheres and the temperature at which the compression unit indicated the highest position was determined as the maximum expansion temperature (Tₘₐₓ [° C.]) of the heat-expandable microspheres.

### Specific Heat of a Blowing Agent

The specific heat of the blowing agent (a) was determined with a differential scanning calorimetry device (DSC4000, manufactured by PerkinElmer). The determination was carried out within the temperature range from −30° C. to 30° C. by elevating the temperature at the rate of 10° C./min.

The heat capacity of a blowing agent at 25° C. was calculated by the following formula from the weight of the blowing agent tested in DSC, the weight of the standard substance tested in DSC, the difference between the DSC curves of the empty sample pan and the sample pan filled with the blowing agent, the difference between the DSC curves of the empty sample pan and the sample pan filled with the standard substance, and the specific heat of the standard substance at 25° C., and the result was defined as the specific heat (Cpe) of the blowing agent. The standard substance used was α-alumina with the specific heat of 0.7639 J/g·K at 25° C.

$$Cpe ( J / g \cdot K ) = ( Ye / Yr ) \times ( Mr / Me ) \times Cpr$$

where Cpe is the specific heat of the blowing agent, Cpr is the specific heat of the standard substance, Ye is the difference between the DSC curves of the empty sample pan and the sample pan filled with the blowing agent, Yr is the difference between the DSC curves of the empty sample pan and the sample pan filled with the standard substance, Me is the weight of the blowing agent tested in DSC, and Mr is the weight of the standard substance tested in DSC.

### Specific Heat of Heat-Expandable Microspheres

The specific heat of the heat-expandable microspheres was determined with a differential scanning calorimetry device (DSC4000, manufactured by PerkinElmer). The heat-expandable microspheres tested in the determination had been dried at 80° C. under reduced pressure of 10 mmHg or less to adjust their moisture content to 1% or less. The determination was carried out within the temperature range from −10° C. to 100° C. by elevating the temperature at the rate of 10° C./min.

The heat capacity of the heat-expandable microspheres at 25° C. was calculated by the following formula from the weight of the heat-expandable microspheres tested in DSC, the weight of the standard substance tested in DSC, the difference between the DSC curves of the empty sample pan and the sample pan filled with the heat-expandable microspheres, the difference between the DSC curves of the empty sample pan and the sample pan filled with the standard substance, and the specific heat of the standard substance at 25° C., and the result was defined as the specific heat (Cps) of the heat-expandable microspheres. The standard substance used was α-alumina with the specific heat of 0.7639 J/g·K at 25° C.

$$Cps ( J / g \cdot K ) = ( Ys / Yr ) \times ( Mr / Ms ) \times Cpr$$

where Cps is the specific heat of the heat-expandable microspheres, Cpr is the specific heat of the standard substance, Ys is the difference between the DSC curves of the empty sample pan and the sample pan filled with the heat-expandable microspheres, Yr is the difference between the DSC curves of the empty sample pan and the sample pan filled with the standard substance, Ms is the weight of the heat-expandable microspheres tested in DSC, and Mr is the weight of the standard substance tested in DSC.

### True Specific Gravity

The true specific gravity of the heat-expandable microspheres, hollow particles and fine-particle-coated hollow particles (hereinafter sometimes simply referred to as microsphere sample(s)) was determined by the following procedure.

Specifically, the true specific gravity of the microsphere samples was determined by the liquid substitution method (Archimedean method) with isopropyl alcohol in an atmosphere at 25° C. and 50% RH (relative humidity) as described below. At first, an empty 100-mL measuring flask was dried and weighed (WB1). Then isopropyl alcohol was poured into the weighed measuring flask accurately to form meniscus, and the measuring flask filled with isopropyl alcohol was weighed (WB2). The 100-mL measuring flask was then emptied, dried, and weighed (WS1). About 50 mL of a microsphere sample were placed in the weighed measuring flask, and the measuring flask containing the microsphere sample was weighed (WS2). Then isopropyl alcohol was poured into the measuring flask containing the microsphere sample to form meniscus accurately without taking bubbles into the isopropyl alcohol, and the flask containing the microsphere sample and isopropyl alcohol was weighed (WS3). The values, WB1, WB2, WS1, WS2, and WS3, were introduced into the following formula to calculate the true specific gravity (d) of the microsphere sample.

$$d = [ ( WS 2 - WS 1 ) \times ( WB 2 ‐ WB 1 ) / 100 ] / [ ( WB 2 - WB 1 ) - ( WS 3 ‐ WS 2 ) ]$$

### Example 1

An aqueous dispersion medium was prepared by adding 100 parts of sodium chloride, 100 parts of colloidal silica containing 20 wt % of silica, and 0.5 parts of polyvinyl pyrolidone in 500 parts of deionized water, and adjusting the pH of the mixture within the range from 2.5 to 3.5.

An oily mixture was prepared by mixing 200 parts of acrylonitrile, 80 parts of methacrylonitrile, 20 parts of methyl methacrylate, 1.6 parts of trimethylolpropane trimethacrylate, 100 parts of methyl perfluoropropyl ether as the blowing agent (a-1), and 2.5 parts of dilauroyl peroxide (trade name: PEROYL L).

The aqueous dispersion medium and oily mixture were mixed and agitated into suspension with a Homo-mixer (TK Homomixer, manufactured by Primix Corporation) at 12,000 rpm until the oily mixture was dispersed into oil globules of the size which is the same as the intended particle size of heat-expandable microspheres.

The suspension was transferred to a nitrogen-purged compressive reactor of 1.5-liter capacity, pressurized to 0.5 MPa, and subjected to polymerization at 60° C. for 5 hours with agitation at 80 rpm followed with the polymerization at 75° C. for 15 hours. After the polymerization, the product was filtered and dried to be prepared into the heat-expandable microspheres of Example 1. The properties of the resultant heat-expandable microspheres and the evaluation result of the microspheres by the testing methods mentioned below are shown in Table 1.

### Examples 2 to 11 and Comparative Examples 1 to 7

In Examples 2 to 11 and Comparative Examples 1 to 7, heat-expandable microspheres of Examples 2 to 11 and Comparative Examples 1 to 7 were obtained in the same manner as in Example 1 except that the components shown in Tables 1 and 2 were used. The properties of the resultant heat-expandable microspheres and the evaluation result of the microspheres by the testing methods mentioned below are shown in Tables 1 and 2.

### Heating Time Required for the Maximum Expansion and Collapse Resistance

A flat-bottomed box 12 cm long, 13 cm wide and 9 cm high was made of aluminum foil and 1.0 g of a sample of heat-expandable microspheres was evenly placed. The sample was heated and expanded for a predetermined time at the temperature calculated by the following formula. Then the true specific gravity of the resultant hollow particles was determined. The expansion ratio (E) of the sample was calculated from the true specific gravity of the hollow particles obtained by the heating (dl) and the true specific gravity of the sample before heating (d0). The heating time was increased until the expansion ratio (E) of the sample reached the maximum. The shortest heating time required for the sample reaching the maximum expansion ratio was defined as the heating time required for the maximum expansion, B1 (sec). Shorter B1 indicates that the heat-expandable microspheres have better expansion performance and exhibit highly thermoresponsive expansion behavior in short time heating.

$$Heating temperature ( ° C . ) = ( Ts + T max ) / 2$$

$$Expansion ratio ( E ) = d 0 / d 1$$

Then a sample of the heat-expandable microspheres was heated at the heating temperature described above for the heating time, B2, calculated by the following formula, and the true specific gravity (d2) of the heated microspheres was determined. The collapse resistance of the heated microspheres was calculated from the d1 and d2 by the following formula. Smaller number indicates that the expanded microspheres are resistant enough to collapse.

$$B 2 ( sec ) = B 1 + 30$$

$$Collapse resistance of microspheres = d 2 / d 1 \times 100$$

### Fragmentation Property (Agglomeration Property)

A sample of heat-expandable microcapsules were dried at 40° C. for 12 hours and 200 g of the dried microcapsules were screened through a sieve (150 μm sieve opening, 100 μm wire diameter, manufactured by Tokyo Screen Co., Ltd.) for 5 min, and the weight (Wp) of the heat-expandable microcapsules which have passed the sieve was measured. The percentage of the heat-expandable microcapsules passing through the sieve was calculated by the following formula and the fragmentation property of the heat-expandable microcapsules was evaluated according to the following criteria. Higher sieve passing percentage indicates that the heat-expandable microcapsules have better fragmentation property and less tendency of agglomeration.
A: 90-% or higher sieve passing showing good fragmentation property
B: sieve passing percentage from 80% to less than 90% showing a little better fragmentation property
C: sieve passing percentage from 70% to less than 80% showing a little poorer fragmentation property
D: sieve passing percentage less than 70% showing poor fragmentation property

$$Sieve passing percentage = Wp / 100$$

Evenness of Formed Product A slurry containing 40-% solid was prepared by mixing 50 parts by weight of heat-expandable microspheres, 50 parts by weight of titanium oxide (0.8 μm mean particle size), 10 parts by weight of a styrene-butadiene latex (SB Latex L-7063, 48-% solid content, manufactured by Asahi Kasei Corporation), 0.5 parts by weight of carboxymethyl cellulose (CELLOGEN 7A, manufactured by DKS Co., Ltd.) as a thickening agent and deionized water. The slurry was spread on an aluminum plate with a bar coater to 300 μm thick and the aluminum plate was heated in an oven at 110° C. to the constant weight to make film containing the heat-expandable microspheres. The area of the film on which without clacks and unevenness occurred was measured by visual observation and the percentage of the measured area to the total area of the film covering the surface of the aluminum plate was calculated. The evenness of the film before heating the heat-expandable microspheres to their maximum expansion was evaluated based on the calculated result according to the following criteria.

Then the film mentioned above was heated in a Geer oven at the maximum expansion temperature (Tₘₐₓ) of the heat-expandable microspheres for 2 min. The area of the film on which clacks and unevenness occurred was measured by visual observation and the percentage of the measured area to the total area of the film covering the surface of the aluminum plate was calculated. The evenness of the film after heating the heat-expandable microspheres to their maximum expansion was evaluated based on the calculated result according to the following criteria.
A: sufficient evenness without any cracks and uneveness
B: acceptable evenness with 1% to 5% area containing cracks and uneveness
C: unacceptable evenness with from over 5% to 20% area containing cracks and uneveness
D: poor evenness with over 20% area containing cracks and uneveness

TABLE 1

| | | | Example | | | | | |
|---|---|---|---|---|---|---|---|---|
| | | | 1 | 2 | 3 | 4 | 5 | 6 |
| Oily | Polymerizable | Acrylonitrile | 200 | 140 | 190 | 170 | 180 | 80 |
| mixture | component | Methacrylonitrile | 80 | 80 | 100 | 125 | 110 | 35 |
| (parts by | | Methacrylic acid | | | | | | 185 |
| weight) | | Methyl methacrylate | 20 | 80 | 10 | 5 | | |
| | | Isobornyl methacrylate | | | | | 10 | |
| | | Methacrylamide | | | | | | |
| | | Styrene | | | | | | |
| | | 1,9ND-A | | 3.0 | | 1.0 | | 3.8 |
| | | TMP | 1.6 | | | | 1.2 | |
| | | TMP-A | | | | 1.0 | | |
| | | EDMA | | | 1.2 | | | |
| | Blowing | Blowing agent a-1 | 100 | | | 50 | | |
| | agent | Blowing agent a-2 | | 40 | | | | |
| | | Blowing agent a-3 | | | 110 | 50 | | |
| | | Blowing agent a-4 | | | | | | 150 |
| | | Blowing agent a-5 | | | | | 55 | |
| | | Isobutane | | | | | | |
| | | Isopentane | | | | | 10 | |
| | Polymerization | SBP | | | | | | |
| | | OPP | | 7.0 | 0.5 | | | 4.5 |
| | | PEROYL L | 2.5 | | 1.5 | 2.0 | 3.0 | |
| | | AIBN | | | | | | |

| Parts by weight of methacrylonitrile to 100 | | 40 | 57 | 53 | 74 | 61 | 44 |
|---|---|---|---|---|---|---|---|
| parts by weight of acrylonitrile | | | | | | | |
| Properties of | A50(μm) | 8.0 | 120.0 | 11.5 | 15.0 | 18.5 | 26.5 |
| heat-expandable | A10(μm) | 6.0 | 5.0 | 7.0 | 5.5 | 9.0 | 12.0 |
| microspheres | A90(μm) | 11.5 | 29.0 | 49.5 | 33.0 | 48.0 | 35.0 |
| | A50/A10 | 1.3 | 4.0 | 1.6 | 2.7 | 2.1 | 2.2 |
| | A90/A50 | 1.4 | 1.5 | 4.3 | 2.2 | 2.6 | 1.3 |
| | Encapsulation ratio (%) | 25 | 12 | 27 | 25 | 18 | 33 |
| | Ts (° C.) | 125 | 135 | 140 | 130 | 125 | 190 |
| | Tmax (° C.) | 170 | 165 | 185 | 170 | 165 | 235 |
| | Specific heat of heat- | 1.35 | 1.32 | 1.22 | 1.37 | 1.30 | 1.19 |
| | expandable microspheres | | | | | | |
| | (J/g · K) | | | | | | |
| | Specific heat of blowing | 1.30 | 1.31 | 1.26 | 1.30 | 1.39 | 1.10 |
| | agent (J/g · K) | | | | | | |
| Evaluation of | Heating time required for | 50 | 50 | 40 | 60 | 60 | 40 |
| heat-expandable | maximum expansion, B1 | | | | | | |
| microspheres | Collapse resistance | 120 | 110 | 108 | 118 | 110 | 107 |
| | Fragmentation property | 95 | 96 | 97 | 94 | 90 | 90 |
| | | A | A | A | A | A | A |
| | Evenness of film before | A | A | A | A | A | A |
| | maximum expansion | | | | | | |
| | Evenness of film after | A | B | A | A | B | B |
| | maximum expansion | | | | | | |

| | | | Example | | | | |
|---|---|---|---|---|---|---|---|
| | | | 7 | 8 | 9 | 10 | 11 |
| Oily | Polymerizable | Acrylonitrile | 85 | 50 | 150 | 180 | 185 |
| mixture | component | Methacrylonitrile | 65 | 30 | 100 | 105 | 100 |
| (parts by | | Methacrylic acid | 150 | 180 | | | |
| weight) | | Methyl methacrylate | | | 50 | | 15 |
| | | Isobornyl methacrylate | | | | 15 | |
| | | Methacrylamide | | 15 | | | |
| | | Styrene | | 25 | | | |
| | | 1,9ND-A | 1.5 | | 1.5 | | |
| | | TMP | 1.0 | | 1.5 | 1.2 | 0.8 |
| | | TMP-A | | | | | 0.8 |
| | | EDMA | | 2.0 | | | |
| | Blowing | Blowing agent a-1 | | | 90 | 20 | 160 |
| | agent | Blowing agent a-2 | 100 | | | | 70 |
| | | Blowing agent a-3 | | 70 | | 130 | |
| | | Blowing agent a-4 | | | | | |
| | | Blowing agent a-5 | | | | | |
| | | Isobutane | | | | | |
| | | Isopentane | | | 10 | 10 | |
| | Polymerization | SBP | 6.0 | | | | |
| | | OPP | | 4.0 | 5.0 | | |
| | | PEROYL L | | | | 3.0 | 2.5 |
| | | AIBN | | | | | |

| Parts by weight of methacrylonitrile to 100 | | 76 | 60 | 67 | 58 | 54 |
|---|---|---|---|---|---|---|
| parts by weight of acrylonitrile | | | | | | |
| Properties of | A50(μm) | 35.0 | 42.0 | 10.5 | 9.0 | 7.5 |
| heat-expandable | A10(μm) | 6.5 | 6.5 | 5.0 | 5.5 | 5.5 |
| microspheres | A90(μm) | 51.0 | 67.0 | 57.5 | 13.5 | 13.0 |
| | A50/A10 | 5.4 | 6.5 | 2.1 | 1.6 | 1.4 |
| | A90/A50 | 1.5 | 1.6 | 5.5 | 1.5 | 1.7 |
| | Encapsulation ratio (%) | 25 | 19 | 25 | 35 | 43 |
| | Ts (° C.) | 190 | 210 | 135 | 125 | 135 |
| | Tmax (° C.) | 235 | 235 | 160 | 160 | 175 |
| | Specific heat of heat- | 1.23 | 1.47 | 1.38 | 1.24 | 1.38 |
| | expandable microspheres | | | | | |
| | (J/g · K) | | | | | |
| | Specific heat of blowing | 1.31 | 1.26 | 1.42 | 1.27 | 1.30 |
| | agent (J/g · K) | | | | | |
| Evaluation of | Heating time required for | 60 | 80 | 70 | 50 | 60 |
| heat-expandable | maximum expansion, B1 | | | | | |
| microspheres | Collapse resistance | 120 | 109 | 106 | 110 | 109 |
| | Fragmentation property | 91 | 86 | 87 | 91 | 93 |
| | | A | B | B | A | A |
| | Evenness of film before | A | B | B | A | A |
| | maximum expansion | | | | | |
| | Evenness of film after | B | B | B | B | A |
| | maximum expansion | | | | | |

TABLE 2

| | | | Comparative Examples | | | | | | |
|---|---|---|---|---|---|---|---|---|---|
| | | | 1 | 2 | 3 | 4 | 5 | 6 | 7 |
| Oily | Polymerizable | Acrylonitrile | 80 | 200 | 10 | 220 | 220 | 70 | 141 |
| mixture | component | Methacrylonitrile | 80 | 80 | 100 | | 75 | 70 | 114 |
| (parts by | | Methacrylic acid | 140 | | 150 | | | 160 | 45 |
| weight) | | Methyl methacrylate | | 20 | | 80 | 5 | | |
| | | Isobornyl methacrylate | | | | | | | |
| | | Methacrylamide | | | 20 | | | | |
| | | Styrene | | | 20 | | | | |
| | | 1,9ND-A | 1.5 | | 0.6 | | | 1.8 | 1.5 |
| | | TMP | | 2.0 | 0.6 | | | | |
| | | TMP-A | | | | | | | |
| | | EDMA | | | | 1.0 | 2.0 | | |
| | Blowing | Blowing agent a-1 | | | | 50 | | 80 | 90 |
| | agent | Blowing agent a-2 | | | | | | | |
| | | Blowing agent a-3 | | | | | 90 | | |
| | | Blowing agent a-4 | | | | | | | |
| | | Blowing agent a-5 | | | | | | | |
| | | Isobutane | | 90 | | | | | |
| | | Isopentane | 100 | | 120 | | | | |
| | Polymerization | SBP | 2.0 | | | | | 1.5 | 6 |
| | initiator | OPP | | | 5.0 | | | | |
| | | PEROYL L | | | | | | | |
| | | AIBN | | 1.5 | | 2.5 | 1.5 | | |

| Parts by weight of methacrylonitrile to 100 | | 100 | 40 | 1000 | 0 | 34 | 100 | 81 |
|---|---|---|---|---|---|---|---|---|
| parts by weight of acrylonitrile | | | | | | | | |
| Properties of | A50(μm) | 20.5 | 28.0 | 11.5 | 24.5 | 30.0 | 36.5 | 25.0 |
| heat-expandable | A10(μm) | 3.0 | 14.5 | 8.5 | 14.5 | 11.5 | 22.0 | 12.5 |
| microspheres | A90(μm) | 35.0 | 36.0 | 59.5 | 37.5 | 69.0 | 56.0 | 55.0 |
| | A50/A10 | 6.8 | 1.9 | 1.4 | 1.7 | 2.6 | 1.7 | 2.0 |
| | A90/A50 | 1.7 | 1.3 | 5.2 | 1.5 | 2.3 | 1.5 | 2.2 |
| | Encapsulation ratio (%) | 25 | 23 | 28 | 14 | 23 | 21 | 23 |
| | Ts (° C.) | 165 | 120 | 210 | 135 | 125 | 170 | 170 |
| | Tmax (° C.) | 190 | 155 | 270 | 150 | 160 | 190 | 195 |
| | Specific heat of heat-expandable | 1.66 | 1.68 | 1.70 | 1.40 | 1.45 | 1.32 | 1.30 |
| | microspheres (J/g · K) | | | | | | | |
| | Specific heat of blowing agent | 2.27 | 2.30 | 2.27 | 1.30 | 1.26 | 1.30 | 1.30 |
| | (J/g · K) | | | | | | | |
| Evaluation of | Heating time required for | 190 | 180 | 170 | 140 | 130 | 140 | 120 |
| heat-expandable | maximum expansion, B1 | | | | | | | |
| microspheres | Collapse resistance | 310 | 522 | 142 | 621 | 443 | 183 | 354 |
| | Fragmentation property | 71 | 65 | 65 | 67 | 68 | 71 | 73 |
| | | C | D | D | D | D | C | C |
| | Evenness of film before maximum | D | D | D | C | C | C | C |
| | expansion | | | | | | | |
| | Evenness of film after maximum | D | D | D | C | D | D | D |
| | expansion | | | | | | | |

The detail of the substances and materials shown in Tables 1 and 2 and used in the Examples and Comparative Examples are as follows.
1,9NID-A: 1,9-nonanediol diacrylate
TMP: trimethylolpropane trimethacrylate
TMP-A: trimethylolpropane triacrylate
EDMA: ethylene glycol dimethacrylate
Blowing agent a-1: 1,1,1,2,2,3,3-heptafluoro-3-methoxypropane, with a specific heat of 1.30 J/g·K
Blowing agent a-2: 1,1,2,3,3,3-hexafuoropropylmethylether, with a specific heat of 1.31 J/g·K
Blowing agent a-3: 1,1,2,2-tetrafluoroethyl-2,2,2-trifluoroethylether, with a specific heat of 1.26 J/g·K
Blowing agent a-4: dodecacluoro-2-methlpentane-3-on, with a specific heat of 1.10 J/g·K
Blowing agent a-5: (Z)-1,1,1,4,4,4-hexafluoro-2-butene, with a specific heat of 1.20 J/g·K
SBP: di-sec-butylperoxydicarbonate (50% concentration)
OPP: di-2-ethylhexylperoxydicarbonate (70% concentration)
PEROYL L: dilauroyl peroxide
AIBN: 2, 2′-azobisisobutylonitrile

As shown in Tables 1 and 2, the heat-expandable microspheres, which exhibited high expansion performance and highly thermoresponsive expansion behavior in short heating time and were resistant to collapse after expansion, were composed of a thermoplastic resin shell polymerized from the polymerizable component containing a nitrile monomer in which acrylonitrile and methacrylonitrile were essentially contained in a ratio of 100 parts by weight/40 parts by weight to 80 parts by weight and also were composed of a blowing agent encapsulated therein and containing the blowing agent (a) which had a specific heat in the range from 0.8 J/g·K to 2.0 J/g·K. On the other hand, the heat-expandable microspheres of Comparative Examples exhibited poorly thermoresponsive expansion behavior and were poorly resistant to collapse after expansion, because the heat-expandable microspheres of Comparative Examples 1 and 3 to 7 were composed of a thermoplastic resin shell polymerized from the polymerizable component containing a nitrile monomer in which the ratio of acrylonitrile and methacrylonitrile was not 100 parts by weight/40 parts by weight to 80 parts by weight, and the heat-expandable microspheres of Comparative Example 2 were not composed of the blowing agent (a) having a specific heat in the range from 0.8 J/g·K to 2.0 J/g·K.

### INDUSTRIAL APPLICABILITY

The heat-expandable microspheres of the present invention are applicable as a lightweight filler for putties, paints, inks, sealing materials, mortar, paper clay and potteries. Further, the heat-expandable microspheres are applicable in the manufacture of molded products having sound-insulation property, heat-insulation property, heat-shielding property and sound absorbency by mixing with a base component and processing in injection molding, extrusion molding and press molding.

The invention has been described in detail with reference to the above embodiments. However, the invention should not be construed as being limited thereto. It should further be apparent to those skilled in the art that various changes in form and detail of the invention as shown and described above may be made. It is intended that such changes be included within the spirit and scope of the claims appended hereto.

1. Heat-expandable microspheres comprising a thermoplastic resin shell and a blowing agent encapsulated therein and vaporizable by heating;
wherein the thermoplastic resin is a polymer of a polymerizable component containing a nitrile monomer;
wherein the nitrile monomer contains acrylonitrile and methacrylonitrile;
wherein the amount of the methacrylonitrile ranges from 40 parts by weight to 80 parts by weight to 100 parts by weight of the acrylonitrile; and
wherein the blowing agent contains a blowing agent (a) having a specific heat ranging from 0.8 J/g·K to 2.0 J/g·K.

2. The heat-expandable microspheres according to claim 1, wherein the heat-expandable microspheres have a specific heat ranging from 1.05 J/g·K to 1.5 J/g·K.

3. The heat-expandable microspheres according to claim 1, wherein the blowing agent (a) contains at least one substance selected from fluoroketone and hydrofluoroether.

4. The heat-expandable microspheres according to claim 1, wherein the polymerizable component contains at least 25 wt % of the nitrile monomer.

5. The heat-expandable microspheres according to claim 1, wherein the heat-expandable microspheres have a particle size distribution in which the ratio of the 50-% cumulative volume particle size (A50) to the 10% cumulative volume particle size (A10), A50/A10, is at least 1.1.

6. The heat-expandable microspheres according to claim 1, wherein the heat-expandable microspheres have a particle size distribution in which the ratio of the 90-% cumulative volume particle size (A90) to the 50% cumulative volume particle size (A50), A90/A50, ranges from 1.1 to 5.5.

7. Hollow particles manufactured by expanding the heat-expandable microspheres according to claim 1.

8. Fine-particle-coated hollow particles comprising the hollow particles according to claim 7 and a fine-particle material coating the outer surface of the shell of the hollow particles.

9. A composition comprising a base component and the heat-expandable microspheres according to claim 1.

10. The composition according to claim 9, wherein the composition is liquid or paste.

11. A formed product manufactured by forming the composition according to claim 9.

12. A composition comprising a base component and the hollow particles according to claim 7.

13. A composition comprising a base component and the fine-particle-coated hollow particles according to claim 8.

14. The composition according to claim 12, wherein the composition is liquid or paste.

15. The composition according to claim 13, wherein the composition is liquid or paste.
